(19) United States
(12) Patent Application Publication
(10) Pub. No.: US 2008/0293418 A1
(43) Pub. Date: Nov. 27, 2008

(54) MANAGING CALL CONTINUITY BETWEEN NETWORK DEVICES

(75) Inventors: Ojas Thakor Choksi, Herndon, VA (US); Pulin R. Patel, McKinney, TX (US); Zeev V. Lubenski, Richardson, TX (US); Michael Brett Wallis, McKinney, TX (US)

Correspondence Address: FISH & RICHARDSON P.C., P.O. BOX 1022, MINNEAPOLIS, MN, 55440-1022, US

(73) Assignee: MAVENIR SYSTEMS, INC., Richardson, TX (US)

(21) Appl. No.: 12/120,018

(22) Filed: May 13, 2008

Related U.S. Application Data
(60) Provisional application No. 60/939,612, filed on May 22, 2007.

(51) Int. Cl. H04Q 7/20

(52) U.S. Cl. 455/436

(57) ABSTRACT

The present disclosure includes a system and method for managing handovers between network devices. In some implementations, a method includes receiving a request to handover a call session from a femtocell to a macrocell associated with a cellular core network. The femtocell comprise cellular radio technology. A Session Initiation Protocol (SIP) message is generated based, at least in part, on the handover request. The SIP message is transmitted to a communication node associated with the cellular core network.

### CLAIM OF PRIORITY

This application claims priority under 35 USC § 119(e) to U.S. Patent Application Ser. No. 60/939,612, filed on May 22, 2007, the entire contents of which are hereby incorporated by reference.

### TECHNICAL FIELD

This invention relates to network management and, more particularly, to managing call continuity between network devices.

### BACKGROUND

Communication networks include wired and wireless networks. Example wired networks include the Public Switched Telephone Network (PSTN) and the Internet. Example wireless networks include cellular networks as well as unlicensed wireless networks that connect to wire networks. Calls and other communications may be connected across wired and wireless networks.

Cellular networks are radio networks made up of a number of radio cells, or cells, that are each served by a base station or other fixed transceiver. The cells are used to cover different areas in order to provide radio coverage over a wide area. When a cell phone moves from place to place, it is handed off from cell to cell to maintain a connection. The handoff mechanism differs depending on the type of cellular network. Example cellular networks include Universal Mobile Telecommunications System (UMTS), Wide-band Code Division Multiple Access (WCDMA), and CDMA2000. Cellular networks communicate in a radio frequency band licensed and controlled by the government.

### SUMMARY

The present disclosure includes a system and method for managing handovers between network devices. In some implementations, a method includes receiving a request to handover a call session from a femtocell to a macrocell associated with a cellular core network. The femtocell comprise cellular radio technology. A Session Initiation Protocol (SIP) message is generated based, at least in part, on the handover request. The SIP message is transmitted to a communication node associated with the cellular core network.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating an example system for managing handovers between network devices;

FIG. 2 is an illustration of an example handover in the system of FIG. 1;

FIGS. 3A to 3G illustrate example call flows for managing handovers between the femtocell and the macrocell of FIG. 1; and

FIG. 4 is a flow chart illustrating an example method for handover from the femtocell to the macrocell of FIG. 1.

Like reference symbols in the various drawings indicate like elements.

### DETAILED DESCRIPTION

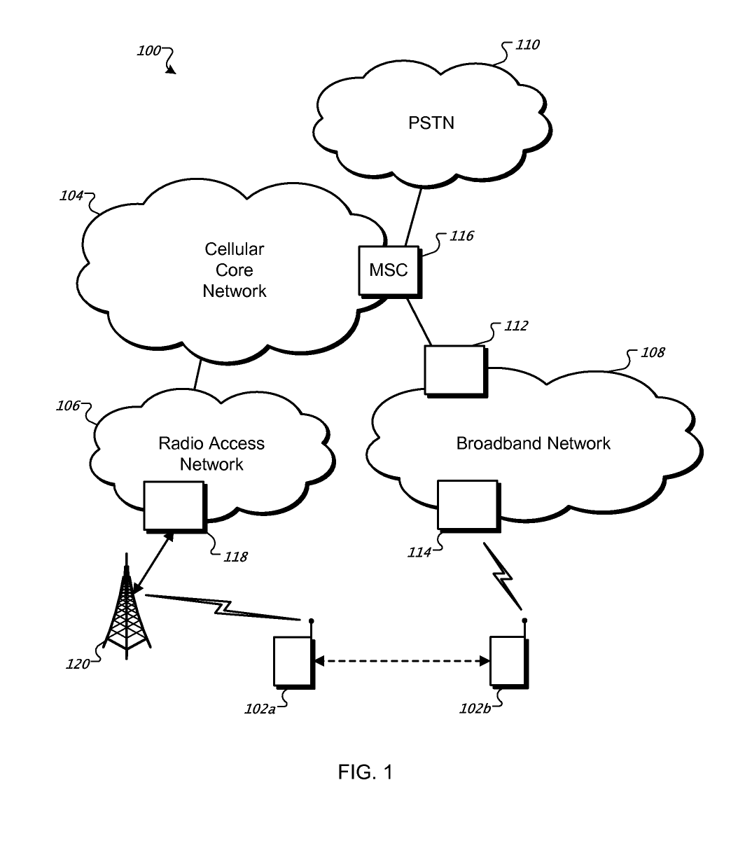

FIG. 1 is a block diagram illustrating communication system 100 for managing wireless devices 102 during handovers between femtocells and macrocells. In general, femtocell devices are radio devices with small coverage footprints, i.e., a femtocell, that allow standard cellular devices to communicate with cellular core networks through Internet Protocol (IP) networks. In some implementations, the associated femtocell includes a range of 100 meters (m) to 200 m and transmit at a power less than or equal to 1 Watt (W). Cellular radio technologies include Global System for Mobile Communication (GSM) protocols, Code Division Multiple Access (CDMA) protocols, Universal Mobile Telecommunications System (UMTS), Worldwide Interoperability for Microware Access (WiMAX) and/or any other suitable protocol for formatting data for cellular communication. Typically, the cellular radio networks consist of Radio Access Networks (RANs) which include several base stations, each radiating radio signals related with the cellular technology over a wide geographic area, i.e., a macrocell. In some implementations, the range of a macrocell is 10 to 1000 times greater than a femtocell. For example, a macrocell may cover 2 km while a femtocell may cover 100 m. In some implementations, the system 100 enables mobile devices 102 to switch between a femto cell and a macrocell. In doing so, mobile devices 102 may switch between accessing services from core networks through two different access networks (e.g., RAN, broadband). In some implementations, the system 100 enables seamless switching between access networks during a communication session. A communication session may be a call, data, video, audio, multimedia or other session in which information and requests are exchanged. As a result, the switching performed by system 100 may provide session call continuity during a handover between a femtocell and a macrocell.

At a high level, system 100 includes mobile devices 102, cellular core network 104, Radio Access Network (RAN) 106, IP network 108, Public Switch Telephone Network (PSTN) 110, communication node 112, and femtocell device 114. Each mobile device 102 comprises an electronic device operable to receive and transmit wireless communication with system 100. As used in this disclosure, mobile devices 102 are intended to encompass cellular phones, data phones, pagers, portable computers, smart phones, personal data assistants (PDAs), one or more processors within these or other devices, or any other suitable processing devices capable of communicating information using cellular radio technology. In the illustrated embodiment, mobile devices 102 are able to transmit in the cellular band. In these cases, messages transmitted and/or received by mobile device 102 are based on a cellular radio technology. There may be any number of mobile devices 102 communicably coupled to RAN 106. Generally, the mobile devices 102 may transmit voice, video, multimedia, text, web content or any other user/client-specific content. In short, device 102 generates requests, responses or otherwise communicates with mobile core networks 104 through RANs 106 and/or IP network 108 via femtocells.

In the illustrated embodiment, cellular core network 104 typically includes various switching elements and gateways for providing cellular services. Cellular core network 104 often provides these services via a number of RANs, such as RAN 106, and also interfaces the cellular system with other communication systems such as PSTN 110 via mobile switching center (MSC) 116. In accordance with the GSM standard, cellular core network 104 includes a circuit switched (or voice switching) portion for processing voice calls and a packet switched (or data switching) portion for supporting data transfers such as, for example, e-mail messages and web browsing. The circuit switched portion includes MSC 116 that switches or connects telephone calls between RAN 106 and PSTN 110 or other network. The packet-switched portion, also known as General Packet Radio Service (GPRS), includes a Serving GPRS Support Node (SGSN) (not illustrated), similar to MSC 116, for serving and tracking mobile devices 102, and a Gateway GPRS Support Node (GGSN) (not illustrated) for establishing connections between packet-switched networks and mobile devices 102. The SGSN may also contain subscriber data useful for establishing and handing over call connections. Cellular core network 104 may also include a home location register (HLR) for maintaining “permanent” subscriber data and a visitor location register (VLR) (and/or a SGSN) for “temporarily” maintaining subscriber data retrieved from the HLR and up-to-date information on the location of mobile devices 102. In addition, cellular core network 104 may include Authentication, Authorization, and Accounting (AAA) that performs the role of authenticating, authorizing, and accounting for devices 102 operable to access cellular core network 104.

PSTN 110 comprises a circuit-switched network that provides fixed telephone services. A circuit-switched network provides a dedicated, fixed amount of capacity (a “circuit”) between the two devices for the duration of a transmission session. In general, PSTN 110 may transmit voice, other audio, video, and data signals. In transmitting signals, PSTN 110 may use one or more of the following: telephones, key telephone systems, private branch exchange trunks, and certain data arrangements. Since PSTN 110 may be a collection of different telephone networks, portions of PSTN 110 may use different transmission media and/or compression techniques. Completion of a circuit in PSTN 110 between a call originator and a call receiver may require network signaling in the form of either dial pulses or multi-frequency tones.

RAN 106 provides a radio interface between mobile devices 102 and cellular core network 104 that may provide real-time voice, data, and multimedia services (e.g., a call) to mobile devices 102. In general, RAN 106 communicates air frames 112 via radio frequency (RF) links. In particular, RAN 106 converts between air frames to physical link based messages for transmission through cellular core network 104. RAN 106 may implement, for example, one of the following wireless interface standards during transmission: IS-54 (TDMA), Advanced Mobile Phone Service (AMPS), GSM standards, CDMA, Wideband CDMA (WCDMA) Time Division Multiple Access (TDMA), General Packet Radio Service (GPRS), ENHANCED DATA rates for Global EVOLUTION (EDGE), HSDPA, EVDO-Rev A. Worldwide Interoperability for Microwave Access (WIMAX), or proprietary radio interfaces.

RAN 106 may include Base Stations (BS) 114 connected to Base Station Controllers (BSC) 116. BS 118 receives and transmits air frames 112 within a geographic region of RAN 106 called a cell and communicates with mobile devices 102 in the cell. Each BSC 120 is associated with one or more BS 118 and controls the associated BS 118. For example, BSC 120 may provide functions such as handover, cell configuration data, control of RF power levels or any other suitable functions for managing radio resource and routing signals to and from BS 118. MSC 116 handles access to BSC 120 and communication node 112, which may appear as a BSC 120 to MSC 116. In some implementations, the communication node 112 may appear as another MSC to MSC 116. MSC 116 may be connected to BSC 120 through a standard interface such as the A-interface.

Network 108 facilitates wireline communication between femotcell device 114 and any other computer. As described, network 108 communicates IP packets to transfer voice, video, data, and other suitable information between network addresses. In communication sessions, network 108 can use the Session Initiation Protocol (SIP) to set up, modify, and tear down calls. Network 108 may include one or more local area networks (LANs), metropolitan area networks (MANs), wide area networks (WANs), all or a portion of the global computer network known as the Internet, and/or any other communication system or systems at one or more locations. In the illustrated implementation, IP network 108 includes SIP proxy servers for routing SIP messages. Each SIP proxy server can be any software, hardware, and/or firmware operable to route SIP messages to other SIP proxies, gateways, SIP phones, femtocell device 114, nodes 112a-c, and others. In some implementations, the SIP messages may encapsulate at least a portion of radio cellular technology and, as a result, the encapsulation can be transparent to standard SIP Proxy servers. In some cases, the radio cellular technology messages may be encapsulated in a MIME extension. The standard SIP proxy servers may only act on the standard SIP headers for routing/forwarding decisions of the SIP message and ignore encapsulations in the message body content header.

The femtocell device 114 can include any software, hardware, and/or firmware operable to wirelessly communicate with mobile phones 102 using cellular messages and translate, map or otherwise convert between cellular messages and SIP messages. For example, the femtocell device 114 may convert between SIP and UMTS or GSM messages. In some implementations, the SIP messages based on the cellular messages may be routed through the IP network 108 using standard SIP processing. In some implementations, the femtocell device 114 may generate SIP messages and transmit the SIP messages to the communication node 112 via IP network 108 thereby tunneling radio cellular technology over the IP network 108. In addition, the femtocell device 114 may receive from the communication node 112 a SIP message encapsulating a cellular message and reconstruct the cellular message based, at least in part, on the SIP message. The femtocell device 114 may generate the SIP messages in response to a discovery process, a call session request received from mobile devices 102, a mobility request received from mobile devices 102, and/or any other suitable event. For example, the femotcell device 114 may receive a request to handover a call session between a femtocell and a macrocell from a mobile device 102 and, in response to at least the request, transmit a SIP message including a handover request to the communication node 112. As mentioned above, the femotcell device 120, in some implementations, transmits messages to communication nodes 112 using SIP. In doing so, the femtocell device 114 may perform two functions when generating the SIP message: (1) encapsulating at least a portion of the cellular message; and/or (2) translating parameters of the cellular message to associated SIP parameters such as SIP headers. In the case of reconstructing the cellular message, the femtocell device 114 may unencapsulate the portion of the cellular message and translate parameters from SIP parameters to cellular-radio-technology parameters.

In regards to encapsulation, the femtocell device 114 may encapsulate a portion of the cellular message in an extension of a conventional SIP message. For example, the femtocell device 114 may add a multipart Multi-Purpose Internet Mail Extensions (MIME) to a standard SIP message with appropriate MIME headers. In some implementations, the femtocell device 114 encapsulates a GSM/UMTS Non-Access Stratum (NAS)/Layer 3 message in a MIME extension of a SIP message. In some implementations, the femtocell device 114 encapsulates the entire GSM/UMTS Mobility Management (MM), Connection Management (CM), and NAS message in the MIME body. Turning to translation, in forming the headers of the SIP message, the femtocell device 114 may translate, map, or otherwise convert parameters from the cellular message to appropriate SIP parameters. For example, the femtocell device 114 may set the ‘To:’ header field in a SIP INVITE requests to the reflected dialed number (Called Party Number) of the received cellular message. In addition, the femtocell device 114 may also convert SIP messages to cellular messages for transmission to cellular devices 102. In particular, the femtocell device 114 may unencapsulate the cellular message from the SIP extension. Also, the femtocell device 114 may translate or otherwise map SIP parameters such as headers to one or more cellular-radio-technology parameters. After the femtocell device 114 generates the cellular message, the femotcell device 114 wirelessly transmits the message to the mobile device 102b.

In general, communication node 112 can include any software, hardware, and/or firmware operable to provide session continuity during handovers between legs using cellular radio technology and legs using broadband technology. For example, mobile device 102 may access core network 104 either through RAN 106 or broadband network 108. In this case, when mobile device 102 switches between a femtocell and macrocell during a session, the communication node 112 may provide continuity of a session between mobile device 102 and cellular core network 104 transparent to another participating core network (e.g., PSTN 110). In other words, communication node 112 may switch between a call leg using a cellular radio technology (e.g., GSM, UMTS) and a call leg using broadband technology (e.g., SIP). In general, a node 112 may be integrated and/or stand alone unit and, in addition, may be part of a rack or system. In some implementations, communication node 112 comprises a system. A system may be a single node, a plurality of nodes, a portion of one or more nodes. A system may be distributed and may cross network boundaries.

In the case that the communication node 112 functions as an MSC (not illustrated), communication node 112 locally manages handovers between the femtocell and the macrocell through a interface with RAN 106 (not illustrated). Communication node 112 may be operable to receive a request from device 102 to generate a call session through the RAN 106 and identify that the device 102 is currently having a call session through the IP network 108. In this case, the communication node 112 may manage authentication and resource assignment for establishing the call session through the cellular core network 104. After performing these steps, the communication node 112 may terminate the call leg through IP network 108 and connect the call leg through RAN 106 to the remaining portion of the existing call session. In doing so, the communication node 112 may provide voice call continuity transparent to the cellular core network 104 participating in the call session. In other words, the communication node 112 may serve as an anchor such that call controls maintained by the core network 104 remain constant.

In managing different communication technologies, the communication node 112 may convert between cellular and/or broadband technologies. For example, the communication node 112 may receive a SIP request from the mobile device 102 to access services from the cellular core network 104. In this case, the communication node 112 may convert the SIP request to a GSM request prior to transmitting the request to cellular core network. The conversion may include conversion between parameters of different communication technologies and/or bit conversion. In addition, the communication node 112 may, in one embodiment, emulate or otherwise represent itself as an element of the cellular core network 104. For example, the communication node 112 may emulate or otherwise represent itself as a BSC, MSC, or other element of the cellular core network 104. In the case that communication node 112 emulates a BSC, the communication node 112 may be queried by the MSC 116 in the cellular core network 104 like any other BSC 120. In the case of communication node 112 emulating an MSC, the communication node 112 may query the BSC 118 and perform call management functions associated with MSCs (e.g., Mobility Management, Call Control, Services).

In one aspect of operation, mobile device 102b transmits a request for a handover to a macrocell associated with the cellular core network 104. During the call section, mobile device 102 periodically monitors the signal level from the femtocell 114 as well as RAN 106 and forward measurements to the femtocell device 114. In response to the signal strength satisfying a threshold, the femtocell device 114 may initiate a handover to a radio call leg to through the RAN 106. The femtocell device 114 transmitis a handover request to the node 112, which in turn would exchange messages with the MSC to effect a successful transfer of the call leg. After establishing the cellular call leg via RAN 106, the broadband call leg can be terminated. In some implementations, the handover between the broadband technology and the cellular communication technology is transparent to the destination core network (e.g., PSTN 110).

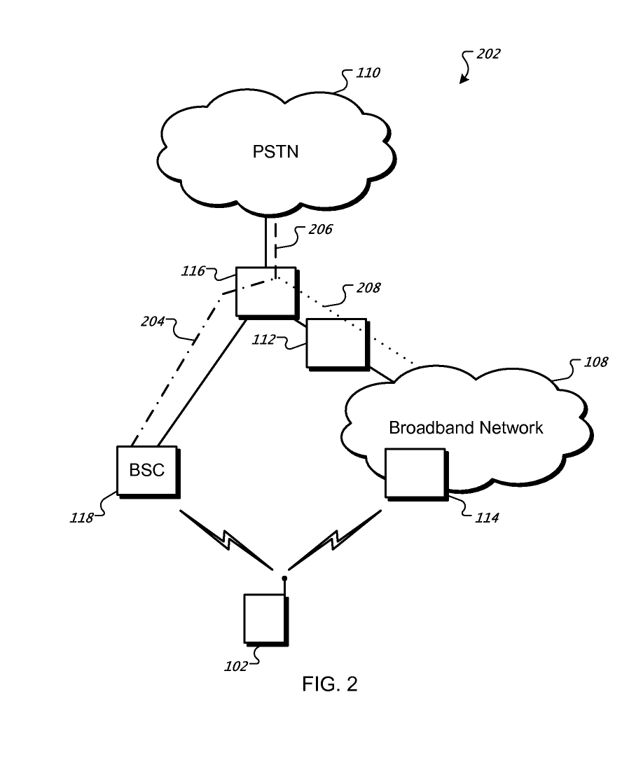

FIG. 2 illustrates a block diagram of a handover in the system of FIG. 1. While the block diagram of FIG. 2 is described with respect to system 100 of FIG. 1, this scenarios could be used by any other system. Moreover, system 100 may use any other suitable implementations for providing voice call continuity during handovers between cellular radio technologies and broadband technologies.

The system 202 includes a communication node 112 that emulates a BSC when managing handovers between different communication technologies. As such, the communication node 112 may perform mobility management, call control, services, as well as the interaccess handover (handover between RAN 106 and broadband network 114). In one aspect of operation, an existing call session between mobile device 102 and PSTN 110 may include a broadband call leg 208 and a call leg 206 between the MSC 116 and PSTN 110. In response to signal degradation of the femtocell, the mobile device 102 transmits a request to establish a call leg through the cellular core network 104 to the femtocell device 114. The femtocell device 114 generates a SIP request indicating a request to handover the cellular device 102 from the femtocell to the macrocell. The request is forward to communication node 116 for performing the management functions. In connection with these processes, the communication node 116 allocates resources through the MSC 116 in the cellular core network 104 and the RAN 106. After the cellular call leg 204 is established, the communication node 116 terminates the broadband call leg 208 and connects the cellular call leg 204 with the call leg 206 to maintain the call session. As a result, the handover between the different technologies may be transparent to the PSTN 110.

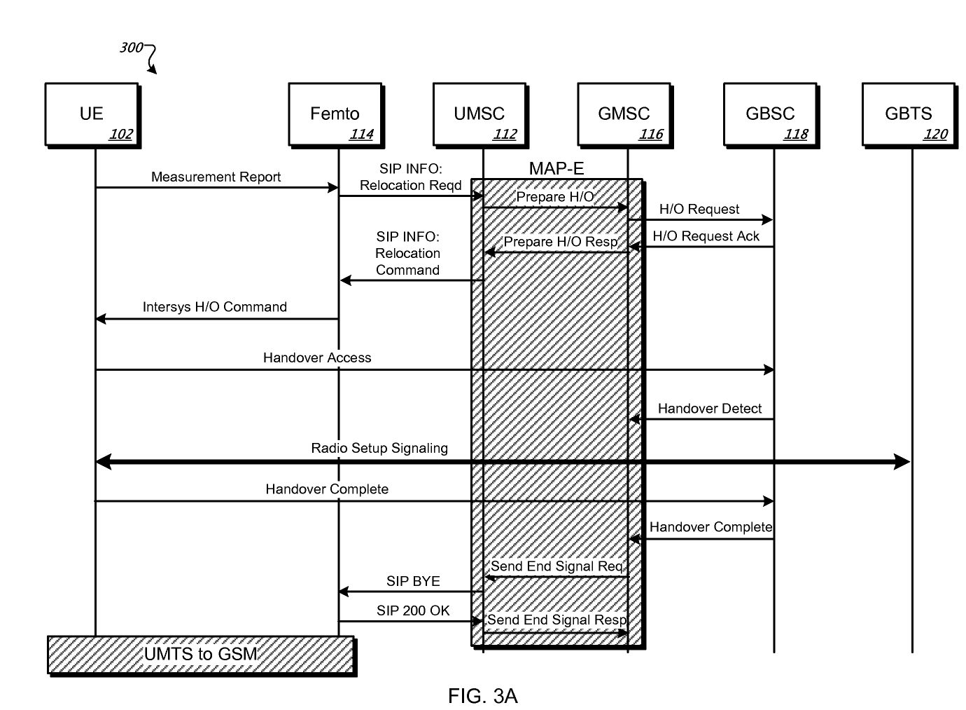

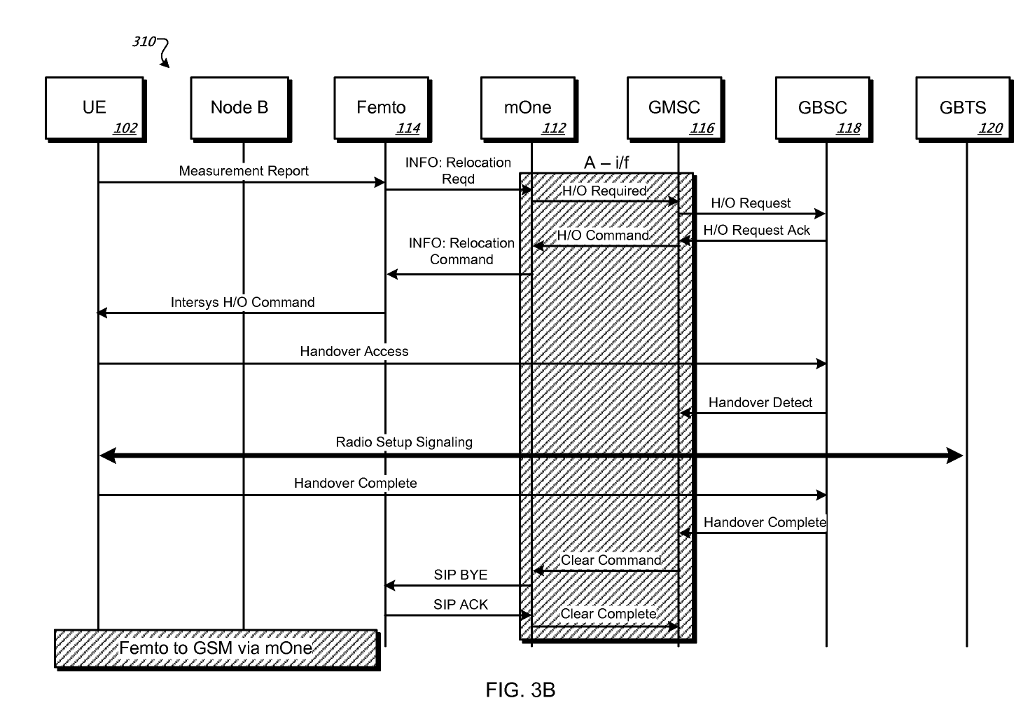

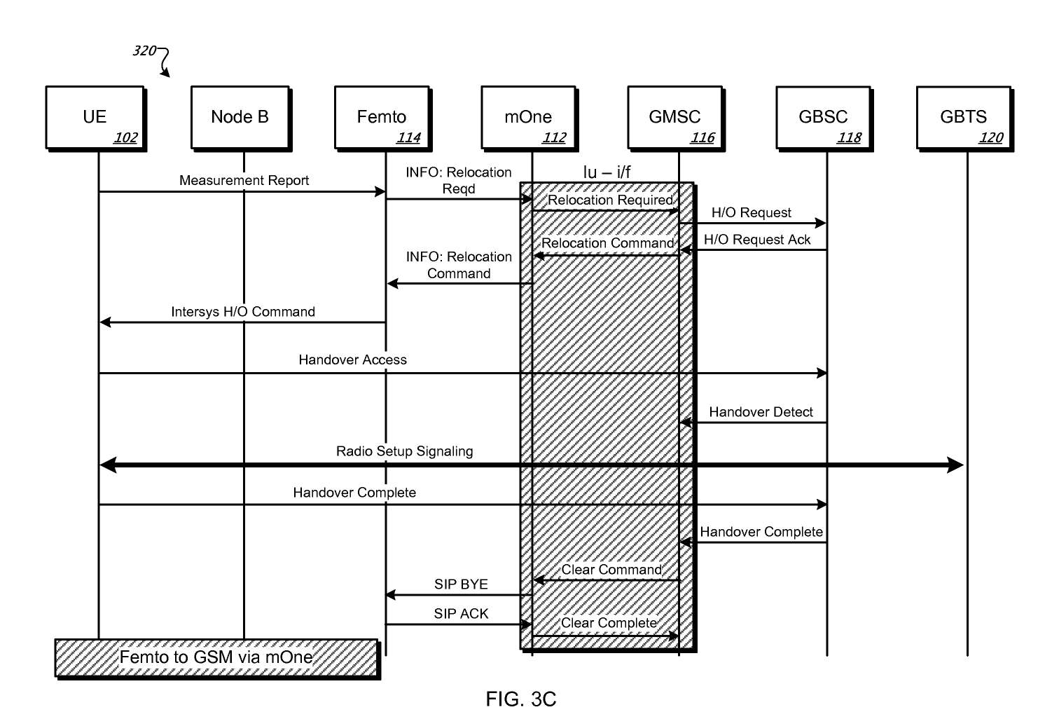

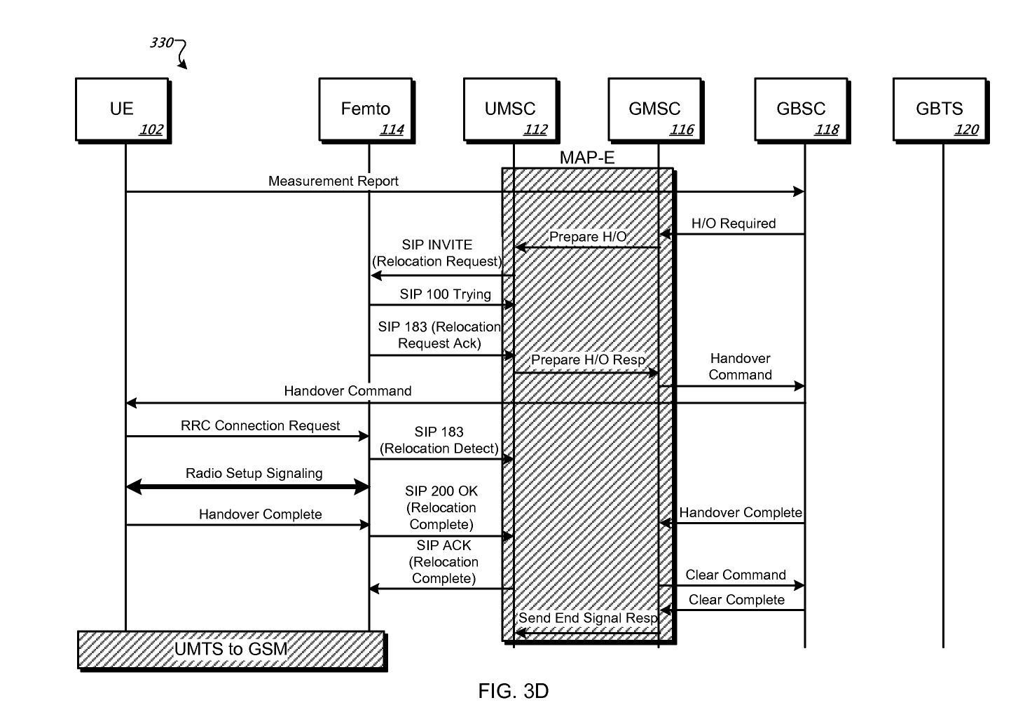

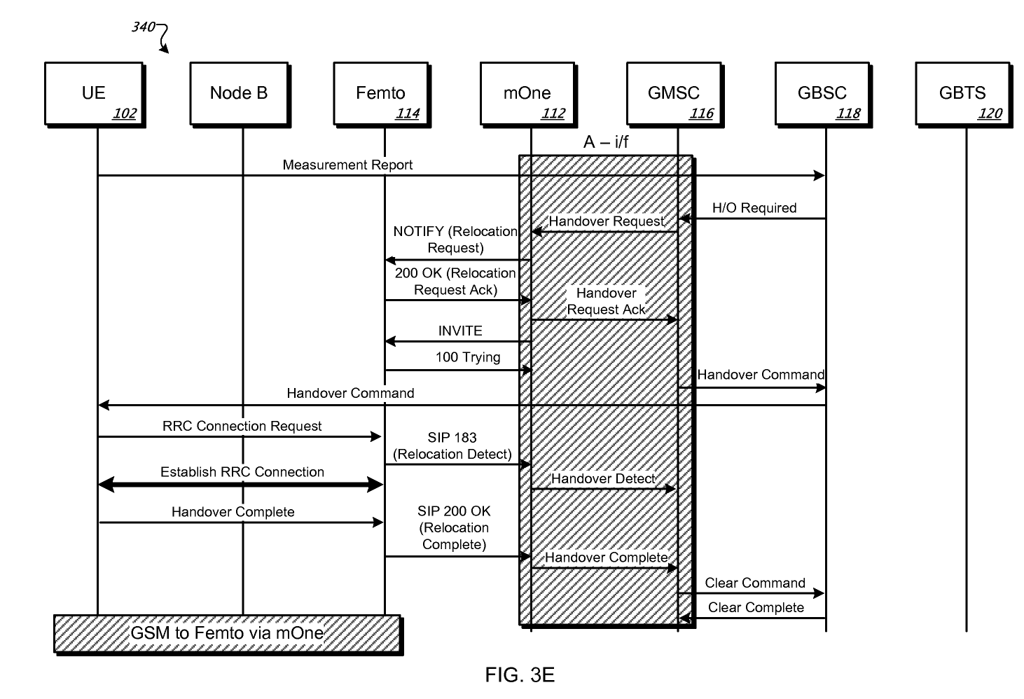

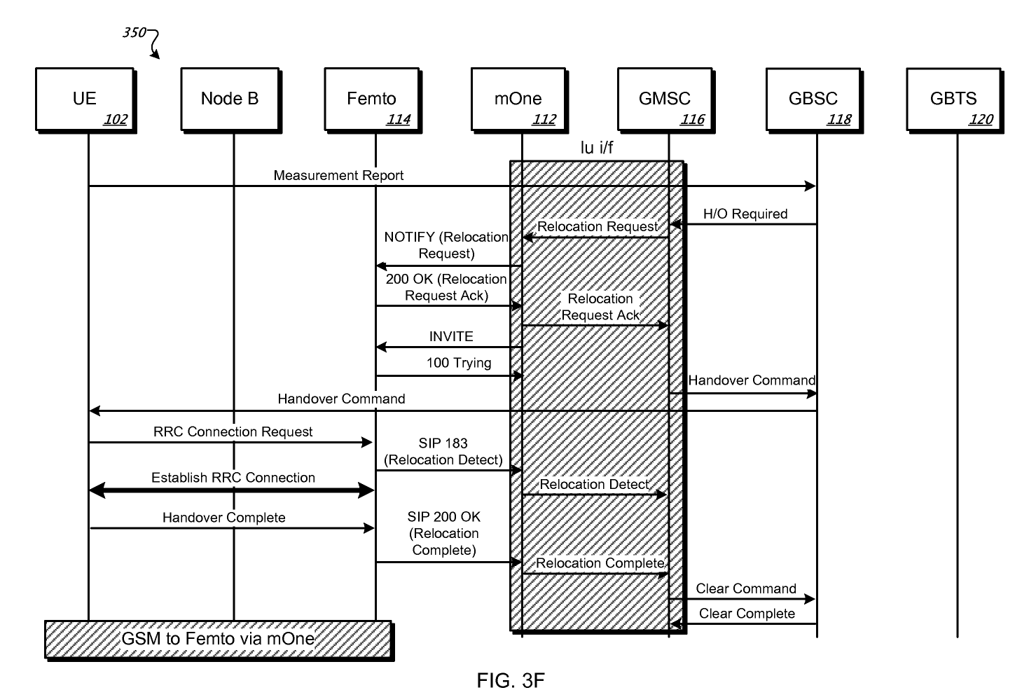

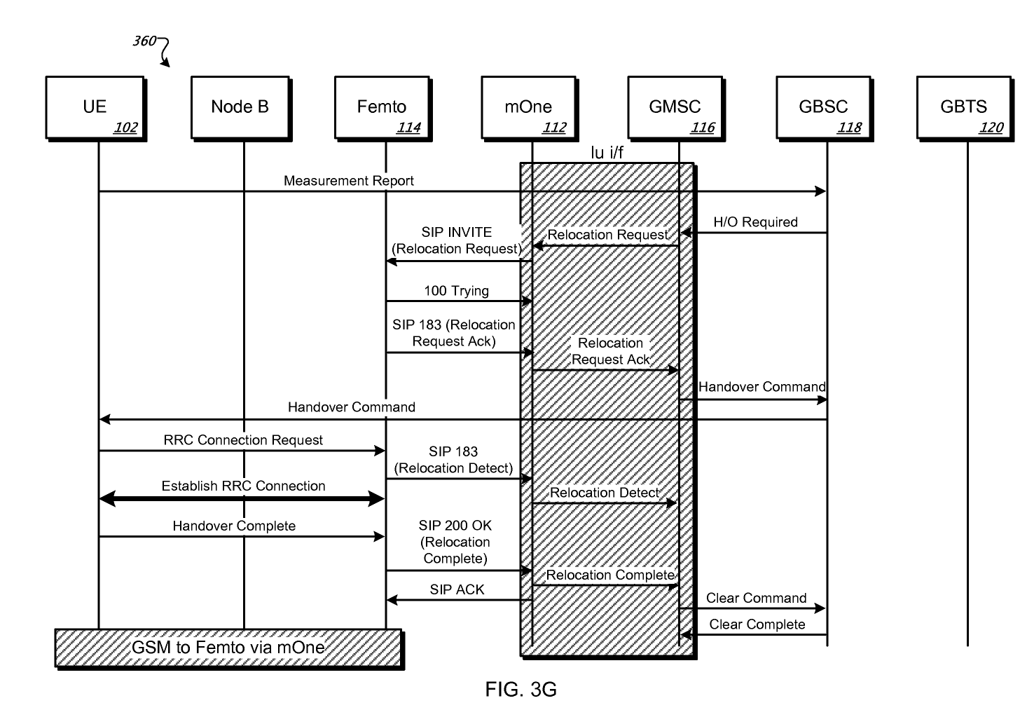

FIGS. 3A to 3G illustrate example call flows for handover call legs between a femtocell and a macrocell in system 100 of FIG. 1. The call flows 300, 310, and 320 illustrate the handover from a femtocell to a macrocell. In some implementations, handover messages may be transmitted through the IP network 108 using a SIP NOTIFY, SIP MESSAGE or SIP INFO. In particular, the call flow 300 illustrates a handover from a UMTS femtocell to a GSM macrocell using an A interface. In this example, the node 112 translates parameters between UMTS and GSM. The call flow 310 illustrates a handover from a UMTS femtocell to a UMTS macrocell using an Iu interface. The call flow 320 illustrates a handover from a GSM femtocell to a UMTS macrocell where the communication node 116 uses a MAP E interface. In this example, the node 112 is represented as an MSC to the MSC 116 and uses an MSC interface defined in GSM/UMTS. The call flows 330, 340, 350, and 360 illustrate handovers from a macrocell to a femtocell. The call flow 330 illustrates a handover from a GSM macrocell to a UMTS femtocell where the communication node 116 uses an A interface. In this example, the node 112 translates parameters between UMTS and GSM. The call flow 340 illustrates a handover from a GSM macrocell to a GSM femtocell using an Iu interface. In this example, the handover messages are transmitted using SIP NOTIFY. The call flow 350 illustrates a handover from a GSM macrocell to a GSM femtocell using an Iu interface and using different SIP messages as compared with the call flow of 340. In this example, the node 112 uses call setup message to embed the handover parameters. The call flow 360 illustrates a handover from a UMTS macrocell to a GSM femtocell where the communication node 116 uses a MAP E interface. In this example, handover parameters are exchanged with the MSC 116 using MSC-MSC interface.

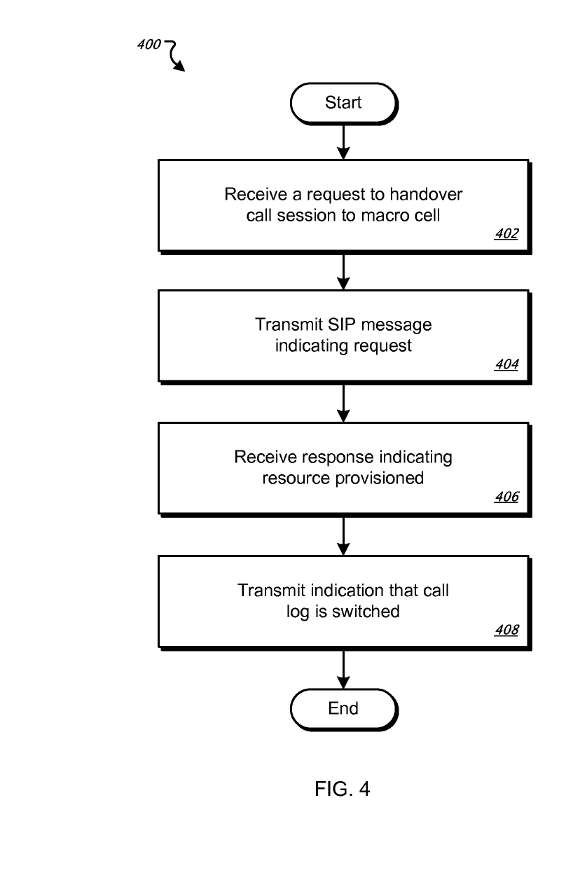

FIG. 4 is a flow chart illustrating an example method 400 for handover a call session from a femtocell to a macorcell in accordance with some implementations of the present disclosure. The illustrated method is described with respect to system 100 of FIG. 1, but this method could be used by any other suitable system. Moreover, system 100 may use any other suitable techniques for performing these tasks. Thus, many of the steps in this flowchart may take place simultaneously and/or in different orders as shown. System 100 may also use methods with additional steps, fewer steps, and/or different steps, so long as the methods remain appropriate.

The method 400 begins at step 402 where a request to handover a call session from a femtocell to a macrocell is received. For example, the femtocell device 114 may receive a handover request from the cellular device 102 using cellular radio technology. In response to at least the request, a SIP message indicating the handover request is transmitted to a communication node associated with the mobile core network. In the example, the femtocell device 114 may generate a SIP message (e.g., INVITE, NOTIFY, INFO, MESSAGE) based, at least in part, on the handover request and transmit the SIP message to the communication node 112 associated with the cellular core network 104. At step 306, a response indicating that the resources have been provisioned in the cellular core network 104 and RAN 106 is received. As for the example, the femtocell device 114 may receive a SIP response indicating that the resources are provisioned. In response to at least the response, an indication that the call is switched is transmitted using cellular radio technology. Returning to the example, the femtocell device 114 may generate a cellular message based, at least in part, on the SIP response and transmit the cellular message to the cellular device 102. Similarly, a handover may offer from the macrocell to the femtocell.

A number of implementations of the invention have been described. Nevertheless, it will be understood that various modifications may be made without departing from the spirit and scope of the invention.

What is claimed is:

1. A method for managing a handover, comprising:
receiving a request to handover a call session from a femtocell to a macrocell associated with a cellular core network, the femtocell comprising cellular radio technology;
generating a Session Initiation Protocol (SIP) message based, at least in part, on the handover request; and
transmitting the SIP message to a communication node associated with the cellular core network.

2. The method of claim 1, wherein the cellular radio technology comprises one of GSM, UMTS, WIMAX, WCDMA, EVDO, HSDPA, or CDMA.

3. The method of claim 1, wherein the SIP message comprises an INVITE, a NOTIFY, a MESSAGE, or an INFO message.

4. The method of claim 1, further comprising:
receiving a SIP response from the communication node indicating that cellular resources are provisioned for the handover; and
transmitting a cellular-radio-technology message to a cellular device indicating that the resources are provisioned for the handover.

5. The method of claim 1, the cellular radio technology comprises a first cellular radio technology, wherein the cellular core network comprises a different cellular radio technology.

6. The method of claim 1, wherein the communication node translates between SIP and the cellular radio technology.

7. The method of claim 1, wherein the communication node is configured to translate to a plurality of cellular radio technologies.

8. The method of claim 1, further comprising encapsulating at least a portion of the request in the SIP message.

9. The method of claim 8, wherein the at least a portion is encapsulated in a MIME extension.

10. The method of claim 1, further comprising:
transmitting a SIP SUBSCRIBE message to the communication node, the SUBSCRIBE message request subscription to handovers between the femtocell and the macrocell; and
receiving a SIP NOTIFY indicating parameters associated with the subscription to handovers.

11. The method of claim 10, further comprising:
receiving a SIP SUBSCRIBE message from the communication node, the SUBSCRIBE message request subscription to handovers between the femtocell and the macrocell; and
transmitting a SIP NOTIFY indicating parameters associated with the subscription to handovers.

12. The method of claim 1, wherein parameters associated with the handover are received in a SIP INFO or SIP MESSAGE message.

13. A device for managing a handover, comprising:
a wireless receiver configured to receive a request to handover a call session from a femtocell to a macrocell associated with a cellular core network, the femtocell comprising cellular radio technology;
a conversion module configured to generate a Session Initiation Protocol (SIP) message based, at least in part, on the handover request; and
an IP transmitter configured to transmit the SIP message to a communication node associated with the cellular core network.

14. The device of claim 13, wherein the cellular radio technology comprises one of GSM, UMTS, WIMAX, WCDMA, EVDO, HSDPA, or CDMA.

15. The device of claim 13, wherein the SIP message comprises an INVITE, a NOTIFY, or an INFO message.

16. The device of claim 13, further comprising:
an IP receiver configured to receive a SIP response from the communication node indicating that cellular resources are provisioned for the handover; and
a wireless transmitter configured to transmit a cellular-radio-technology message to a cellular device indicating that the resources are provisioned for the handover.

17. The device of claim 13, the cellular radio technology comprises a first cellular radio technology, wherein the cellular core network comprises a different cellular radio technology.

18. The device of claim 13, wherein the communication node translates between SIP and the cellular radio technology.

19. The device of claim 13, wherein the communication node is configured to translate to a plurality of cellular radio technologies.

20. The device of claim 13, further comprising encapsulating at least a portion of the request in the SIP message.

21. The device of claim 20, wherein the at least a portion is encapsulated in a MIME extension.

22. The device of claim 1, further comprising:
the IP transmitter further configured to transmit a SIP SUBSCRIBE message to the communication node, the SUBSCRIBE message request subscription to handovers between the femtocell and the macrocell; and
the IP receiver further configured to receive a SIP NOTIFY indicating parameters associated with the subscription to handovers.

23. The device of claim 22, further comprising:
the IP receiver further configured to receive a SIP SUBSCRIBE message from the communication node, the SUBSCRIBE message request subscription to handovers between the femtocell and the macrocell; and
the IP transmitter further configured to transmit a SIP NOTIFY indicating parameters associated with the subscription to handovers.

24. The device of claim 13, wherein parameters associated with the handover are received in a SIP INFO or SIP MESSAGE message.
